(19) United States
(12) Patent Application Publication
(10) Pub. No.: US 2025/0171033 A1
(43) Pub. Date: May 29, 2025

(54) METHOD AND SYSTEM FOR PLANNING A TRAJECTORY FOR AN AT LEAST PARTIALLY AUTOMATED VEHICLE

(71) Applicant: Robert Bosch GmbH, Stuttgart (DE)

(72) Inventors: Andreas Schmidt, Stuttgart (DE); Johannes Christian Mueller, Stuttgart (DE); Koba Natroshvili, Waldbronn (DE); Marcel Schreiber, Neu-Ulm (DE)

(21) Appl. No.: 18/954,619

(22) Filed: Nov. 21, 2024

(30) Foreign Application Priority Data
Nov. 28, 2023 (DE) 10 2023 211 865.3

(51) Int. Cl. B60W 50/00; B60W 60/00

(52) U.S. Cl. CPC B60W 50/0097; B60W 2050/0028; B60W 60/001; B60W 2556/10

(57) ABSTRACT

A method for planning a trajectory for an at least partially automated vehicle. The method includes: providing a trained machine learning model for determining the occupancy of an occupancy grid, the machine learning model is trained to predict the occupancy of the occupancy grid at a subsequent time from a history of occupancies; generating a temporal sequence of occupancies of the occupancy grid using measurement data from the environment of the vehicle; evaluating, using the trained machine learning model, the sequence of occupancies that were generated, to predict a total occupancy of the occupancy grid at a current time; comparing the predicted occupancy of the occupancy grid at a current time to the occupancy determined using measurement data, determining a location-dependent measure of a reliability of the occupancy information depending on the comparison; planning a trajectory for the at least partially automated vehicle based on the reliability.

### CROSS REFERENCE

The present application claims the benefit under 35 U.S.C. § 119 of German Patent Application No. DE 10 2023 211 865.3 filed on Nov. 28, 2023, which is expressly incorporated herein by reference in its entirety.

### FIELD

The present invention relates to a method and system for planning a trajectory for an at least partially automated vehicle. The present invention also relates to a computer program.

### BACKGROUND INFORMATION

Self-driving vehicles, i.e., vehicles that are driven in an at least partially automated manner, must be able to recognize and assess their surroundings. A common system chain generally comprises a perception module, which processes data about the environment of the vehicle, which are acquired by one or more environmental sensors, and generates information therefrom.

Two frequently found representations of the environment are object lists and occupancy grids (hereinafter also referred to merely as grids). Object lists are based on object hypotheses and describe detected objects, such as pedestrians, cyclists, or cars, for example with oriented bounding boxes with additional attributes such as velocity or classification. Occupancy grids, in turn, provide a sensor-based image of the environment, in which specific lidar measurement points result in occupied cells, for example. By converting sensor-based information directly into a grid representation, the complexity and, in particular, the susceptibility to errors of object formation is eliminated.

A downstream planning module uses this information about the environment of the vehicle and can derive driving decisions therefrom. The output of the perception modules is checked for freedom from collision, and a trajectory for the driving task in the current situation is determined via cost functions and, for example, by machine learning (ML) methods.

Unpredictable and unknown scenarios pose a risk to the entire system chain and thus to the safety of the driving function. This in particular affects model-based modules, which inherently cannot represent all eventualities, but also ML methods that must work with input data that were not known at the design time/training time. In order to eliminate or mitigate these issues, out-of-distribution (OOD) techniques can be used: As soon as it is determined at runtime that the system reaches the limits of the known situations, the situation is mitigated, for example by purposely braking.

Such techniques are, for example, described in German Patent Application No. DE 10 2023 205 459.0.

U.S. Patent No. U.S. Pat. No. 11,433,922 B1 describes a method for controlling a more highly or highly automated vehicle in which an ML model is used to output an uncertainty metric. A vehicle can determine a traveled trajectory associated with the object and can ascertain a difference between the traveled trajectory and the set of candidate trajectories. On the basis of the difference, the vehicle can determine an uncertainty metric associated with the object.

U.S. Patent Application Publication No. US 2023/031375 A1 describes a method for controlling a more highly or highly automated vehicle with an ML model. The method comprises a training system with training data located remotely from the vehicle (onboard system). Furthermore, the ML model uses sensor data of the vehicle to create an obtained intent prediction or predicted probability.

### SUMMARY

Providing a reliable method for controlling a vehicle driven in an at least partially automated manner may therefore be an object of the present invention.

Providing a highly reliable driving assistance system for interconnected motor vehicles driven in an at least partially automated manner may be a further object of the present invention.

According to an example embodiment of the present invention, occupancy grids are used to represent the vehicle environment. Occupancy grids provide a sensor-based image of the environment, in which specific lidar measurement points result in occupied cells of the occupancy grid, for example. By converting sensor-based information directly into a grid representation, the complexity and, in particular, the susceptibility to errors of object formation is eliminated. In this regard, grids offer a great advantage over a representation in the form of objects.

Providing reliable and safe planning of a trajectory for an at least partially automated vehicle on the basis of occupancy grid information may be considered as an object of the present invention.

According to a first aspect of the present invention, a method for planning a trajectory for an at least partially automated vehicle is provided. According to an example embodiment of the present invention, the method comprises the following steps:
a) Providing a machine learning model, trained in advance, for determining the occupancy of an occupancy grid. The machine learning model is trained in advance to predict the occupancy of the occupancy grid at a subsequent time t0 from a history of a specific length H, i.e., a temporal sequence of given occupancies of the occupancy grid. The term “occupancy of the occupancy grid” may, for example, be understood to mean a function that assigns a value to each cell (ij) of the occupancy grid, wherein the value specifies whether or with what probability the cell is occupied.
b) Generating a temporal sequence of occupancies by acquiring measurement data from the environment of the vehicle at successive times t0-H, . . . t0-2, t0-1, to by means of at least one environmental sensor of the vehicle and calculating a respective occupancy B(t0-H), . . . B(t0-2), B(t0-1), B(t0) of the occupancy grid therefrom. The measurement data may, for example, be measurement data of a lidar sensor system of the vehicle. This measurement data may, for example, be collected at regular intervals of 100 milliseconds and temporarily stored.
c) The thus determined sequence of occupancies is evaluated by means of the machine learning model trained in advance, in order to predict an occupancy G(t0) of the occupancy grid at a current time t0.
d) The predicted occupancy G(t0) of the occupancy grid at the current time t0 can now be compared to the occupancy B(t0) determined by means of measurement data, wherein deviations between the measurement and the prediction are in particular detected. Depending on the comparison, a location-dependent measure of a reliability of the occupancy information can be determined. The term “occupancy information” is in particular to be understood to mean a statement as to whether or not a spatial area is occupied in reality, which area is represented by a corresponding area, e.g., an individual cell and/or a group of cells of the occupancy grid.
e) On the basis of this measure of reliability, a trajectory for the at least partially automated vehicle can be planned, in particular on the basis of detected deviations and/or a degree of uncertainty.

In a preferred example embodiment of the present invention, a measure of reliability can be determined for a specific spatial area of the current occupancy depending on the deviation between the measurement B(t0) and the prediction G(t0). This measure may in particular be dependent on a deviation and/or measurement uncertainty, wherein an area comprises at least one cell (ij) and/or multiple contiguous cells (ij) of the occupancy grid.

In a preferred example embodiment of the present invention, a subjective logic opinion can be determined for determining the reliability for each cell (ij) of the occupancy grid. According to the principle of subjective logic opinion, a tuple (bᵢⱼ, dᵢⱼ, uᵢⱼ, aᵢⱼ) can in particular be determined for each cell (ij) for this purpose, wherein bᵢⱼ represents a match between the measurement and the prediction of the occupancy of the cell (ij), dᵢⱼ represents a deviation between the measurement and the prediction of the occupancy of the cell (ij), uᵢⱼ represents an uncertainty of the occupancy of the cell (ij), and aᵢⱼ represents a basic probability of the occupancy of the cell (ij). The uncertainty, which may also be referred to as epistemic uncertainty, represents the model-related uncertainty. For example, cells (ij) for which the measurement data have a high uncertainty or low quality and/or for which the prediction has a high uncertainty have a high value for uᵢⱼ. By applying subjective logic in this way and by locally evaluating on the basis of occupancy grids, a very information-rich and meaningful analysis of the existing certainty/uncertainty can be generated. For example, this may be used directly in a planning module by advantageously planning trajectories to avoid cells (ij) with a high uncertainty uᵢⱼ or to traverse them at a reduced velocity.

Thus, preferably in step e), a trajectory planning for the vehicle can take place such that cells and/or areas of cells of the occupancy grid with a high deviation dᵢⱼ and/or a high uncertainty uᵢⱼ are avoided and/or areas with a high match bᵢⱼ are preferred. Here, individual cells (ij) or contiguous areas of cells may be considered. In this way, a trajectory as safe as possible can advantageously be planned efficiently.

In other words, generating a statement about the awareness of the situation or the development of the situation in the environment of an at least partially autonomously driven vehicle may be considered as an aim of the present invention. In order to achieve this, a machine learning model is used, which aims at predicting, at a specific time t0, the occupancy at the current time t0 from a specific history of length H of occupancy grids G(t-1), G(t-2), . . . G(t-H). The method is trained offline on a suitable training data set. A great advantage of this method is that no manual labels are required for the training of the machine learning model. The input data (occupancy grid G(t-1),

G(t-2), . . . G(t-H)) may also simultaneously serve as labels for the optimization of the prediction network. Finally, for execution in an at least partially automated vehicle, the predicted occupancy is compared to the occupancy grid obtained from current sensor information. Deviations from the prediction and the actual measurement can then be assessed as potentially hazardous areas since the prediction was unable to predict the future occupancy with sufficient quality.

The occupancy grid predicted from the history is subsequently compared to the occupancy grid fused from sensor data at runtime. The comparison may provide various outputs: In the simplest case, a cell-by-cell comparison is carried out, and the difference between prediction and sensor information is calculated per cell (ij). Even this simple output makes it possible to specifically identify areas in the occupancy grid that were particularly poorly predicted. Finally, this cell-wise norm can be used to derive a statement of how good the prediction was.

In one advantageous example embodiment of the present invention, prior to the processing by the machine learning model and/or prior to the comparison, the occupancy grids are transformed such that the ego movement of the vehicle is compensated. This ensures that the occupancy grid is decoupled from the vehicle movement and can thus be compared at any time.

In one advantageous example embodiment of the present invention, the input data for the machine learning model (ML) comprise 3D tensors, wherein the 3D tensors each comprise occupancy grids of a specific environment at different times.

In this case, the output data of the machine learning model in particular comprise an occupancy grid of the same dimensions as the occupancy grids of the input data, but only for a specific time t0.

In an alternative advantageous example embodiment of the present invention, the machine learning model comprises an architecture in which the spatial and temporal dimensions of the input data are processed separately.

In an alternative advantageous example embodiment of the present invention, the machine learning model comprises a recurrent network.

According to a second aspect of the present invention, a computer program is proposed. The computer program comprises commands that, when executed by a processor, cause the processor to carry out a method according to the first aspect.

According to a third aspect of the present invention, a system for planning a trajectory for an at least partially automated vehicle is proposed, comprising a machine learning module (ML), a perception module, an interface for receiving environmental sensor data, a comparison module, and a planning unit, wherein the system is designed to perform a method according to the first aspect. The interface may, for example, be designed to receive or read measurement data of one or more environmental sensors, e.g., of a vehicle. It is also possible that the measurement data are provided by an external source, e.g., a cloud service or an infrastructure unit. The measurement data may, for example, be measurement data of a lidar sensor and/or of a (mono or stereo) camera system.

According to a fourth aspect of the present invention, a vehicle configured to drive in an at least partially automated manner and comprising a system according to the third aspect is provided.

By means of the present invention, it is thus possible to generate a statement about the awareness of the situation or the development of the situation or the reliability of the information represented by the occupancy grid and to adjust a trajectory planning for the at least partially automated vehicle to this awareness. For example, a planning module may use this information and evaluate possible trajectories on the basis of the specific uncertainties. It is thus possible to avoid areas of great uncertainty or to prefer areas of high prediction quality and low epistemic uncertainty.

In contrast to previous approaches to the complex of topics of anticipatory driving, the present invention uses out-of-distribution (OOD) methods on the basis of occupancy grids instead of object lists. This provides the advantage that sensor-based information can be entered directly into the occupancy grid without error-prone intermediate processing. This avoids unfavorable incorrect detections as can commonly or easily occur in the case of object lists.

In addition, by combining subjective logic opinion and by locally evaluating on the basis of occupancy grids, a very information-rich and meaningful analysis of the existing certainty/uncertainty can be generated. This can be used directly in the planning module to avoid, for example, areas with greater uncertainty or to traverse them more slowly.

The present invention thus makes safe and efficient trajectory planning for at least partially automated vehicles possible.

The term “at least partially automated” in particular includes one or more of the following cases: assisted driving, partially automated driving, highly automated driving, fully automated driving of a vehicle, in particular of a motor vehicle.

Assisted driving means that a driver of the vehicle continuously performs either the lateral guidance or the longitudinal guidance of the vehicle. The respectively other driving task (i.e., controlling the longitudinal guidance or lateral guidance of the vehicle) is carried out automatically. That is to say, either the lateral guidance or the longitudinal guidance is controlled automatically when the vehicle is driven in an assisted manner.

Partially automated driving means that, in a specific situation (for example: driving on a freeway, driving in a parking lot, passing an object, driving within a lane defined by lane markings) and/or for a certain period of time, a longitudinal guidance and a lateral guidance of the vehicle are controlled automatically. A driver of the vehicle does not have to manually control the longitudinal guidance and lateral guidance of the vehicle. However, the driver must continuously monitor the automatic control of the longitudinal guidance and lateral guidance in order to be able to intervene manually when necessary. The driver must be ready at all times to fully take over the driving of the vehicle.

Highly automated driving means that, for a certain period of time in a specific situation (for example: driving on a freeway, driving in a parking lot, passing an object, driving within a lane defined by lane markings), longitudinal guidance and lateral guidance of the vehicle are controlled automatically. A driver of the vehicle does not have to manually control the longitudinal guidance and lateral guidance of the vehicle. The driver does not have to continuously monitor the automatic control of the longitudinal guidance and lateral guidance in order to be able to intervene manually when necessary. When necessary, a take-over request to take over control of the longitudinal guidance and lateral guidance is automatically issued, in particular issued with a sufficient time reserve, to the driver. The driver thus has to potentially be able to take control of the longitudinal guidance and lateral guidance. Limits of the automatic control of the lateral guidance and longitudinal guidance are detected automatically. In highly automated driving, it is not possible to automatically bring about a minimal risk state in every initial situation.

Fully automated driving means that, in a specific situation (for example: driving on a freeway, driving in a parking lot, passing an object, driving within a lane defined by lane markings), longitudinal guidance and lateral guidance of the vehicle are controlled automatically. A driver of the vehicle does not have to manually control the longitudinal guidance and lateral guidance of the vehicle. The driver does not have to monitor the automatic control of the longitudinal guidance and lateral guidance in order to be able to intervene manually when necessary. Before the automatic control of the lateral guidance and longitudinal guidance is ended, the driver is automatically requested to take over the driving task (control of the lateral guidance and longitudinal guidance of the vehicle), in particular with a sufficient time reserve. If the driver does not take over the driving task, return to a minimal risk state takes place automatically. Limits of the automatic control of the lateral guidance and longitudinal guidance are detected automatically. In all situations, it is possible to automatically return to a minimal risk system state.

Driverless control or driving means that, independently of a specific use case (for example: driving on a freeway, driving within a parking lot, passing an object, driving within a lane defined by lane markings), longitudinal guidance and lateral guidance of the vehicle are controlled automatically. A driver of the vehicle does not have to manually control the longitudinal guidance and lateral guidance of the vehicle. The driver does not have to monitor the automatic control of the longitudinal guidance and lateral guidance in order to be able to intervene manually when necessary. The longitudinal guidance and lateral guidance of the vehicle is thus controlled automatically, for example for all road types, velocity ranges and environmental conditions. The entire driving task of the driver is thus taken over automatically. The driver is therefore no longer required. That is to say, the vehicle can drive even without a driver from any starting position to any desired destination position. Potential problems are solved automatically, i.e., without the help of the driver.

Further advantages, features and details of the present invention become clear from the following description, which describes example embodiments of the present invention in detail with reference to the figures. In this context, each feature disclosed herein may be essential to the present invention individually or in any combination.

### BRIEF DESCRIPTION OF THE DRAWINGS

FIG. 1 shows, by way of example, an occupancy grid for an environment of a vehicle.

FIG. 2 schematically shows the training process of a machine learning model that can be used within the scope of the present invention.

FIG. 3 shows a flow chart of an exemplary embodiment of a method according to the present invention for planning a trajectory for an at least partially automated vehicle.

FIG. 4 schematically shows an exemplary embodiment of a system according to the present invention for planning a trajectory for an at least partially automated vehicle.

### DETAILED DESCRIPTION OF EXAMPLE EMBODIMENTS

In the following description of the exemplary embodiments of the present invention, the same elements are labeled with the same reference signs and a repeated description of these elements is omitted where appropriate. The figures show the subject matter of the present invention only schematically.

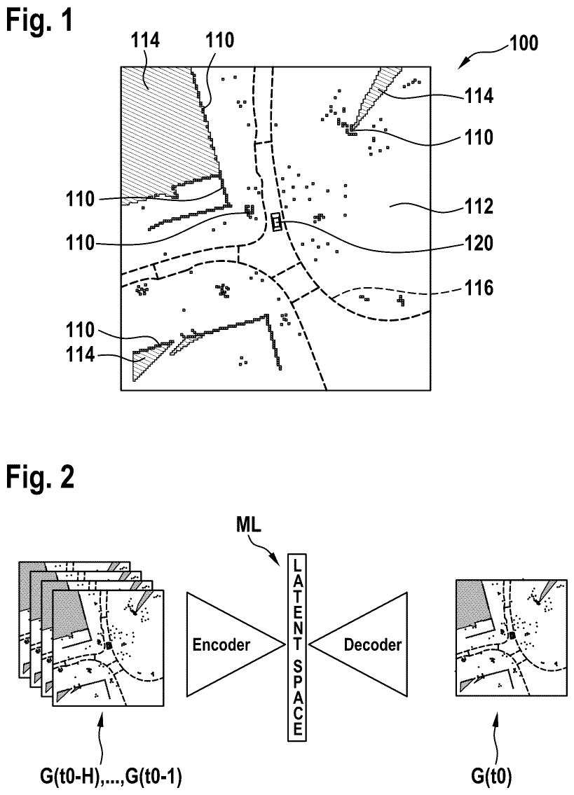

FIG. 1 shows an exemplary representation of an occupancy grid 100. Each pixel in the representation corresponds to a cell (ij) of the occupancy grid 100. The ego vehicle 120 is located at the center of the occupancy grid 100 (so-called birds-eye view representation). The occupancy grid 100 or the occupancy information contained therein may have been generated by measurement or by a prediction by means of a machine learning model. The areas 110 of the occupancy grid 100 comprise cells that are assumed to be occupied and may, for example, be produced by lidar reflections received by a lidar sensor of the vehicle 120. The areas 114 are unknown areas or areas not visible by means of the lidar sensor. In this example, the occupancy grid 100 is underlaid with map information 116, here a course of a road. This map information can additionally be included, e.g., as a boundary condition or basic probability in a subjective logic opinion, in the evaluation and the determination of the reliability of the occupancy information within the scope of the present invention.

FIG. 2 illustrates the machine learning algorithm that may preferably be used in the present invention.

The algorithm comprises a prediction network ML that is trained (offline) in advance and, in the automated vehicle, at runtime (online), performs the prediction of the occupancy (prediction) and also carries out the determination of the subjective logic opinions. In both cases, i.e., during the training and at runtime, the input data of the prediction network ML comprise a history of length H of occupancy data of an occupancy grid G(t0-1), G(t0-2), . . . G(t0-H). The output in each case is a predicted occupancy of the occupancy grid at the current time t0 (G(t0)).

First, in both cases, the ego movement of the vehicle is compensated in order to locally associate the occupancy grids. One way of compensation is to transform the occupancy data of the occupancy grids (G(t0-1), G(t0-2), . . . G(t0-H)) on the basis of the movement of the vehicle to the time t0. This decouples the prediction from the ego movement. The history of the occupancy data of the occupancy grid may, for example, be stored in a buffer and transferred to a suitable network. For this purpose, there are a variety of architectures and characteristics that have different advantages and disadvantages. They are described in the related art. The input data may, for example, be 3D tensors consisting of the occupancy grids of multiple time steps. In this case, the number of input channels is identical to the number of time steps times the number of channels per occupancy grid. The encoder-decoder architecture ML results at the network output in a grid of the same dimension as the occupancy grids at the input, but only for one time t0. An alternative to this realization is the use of an architecture as described in Wu, P., Chen, S., “MotionNet: Joint Perception and Motion Prediction for Autonomous Driving Based on Bird's Eye View Maps,” IEEE Conference on Computer Vision and Pattern Recognition (CVPR), DOI: 10.1109/CVPR42600.2020.01140, June 2020, pp. 11382-11392, in which the spatial and temporal dimensions are processed separately. Another way is by means of recurrent networks as described, for example, in M. Schreiber, V. Belagiannis, C. Gläser and K. Dietmayer, “Dynamic Occupancy Grid Mapping with Recurrent Neural Networks,” 2021 IEEE International Conference on Robotics and Automation (ICRA), Xi'an, China, 2021, pp. 6717-6724, doi: 10.1109/ICRA48506.2021.9561375. The output from the networks can, in the simplest case, represent a predicted occupancy grid G(t0) at time t0.

The grid G(t0) predicted from the history is subsequently compared to the occupancy grid B(t0) fused from sensor data at runtime. For this purpose, the ego movement of the vehicle is also first compensated. The comparison may provide various outputs: In the simplest case, a cell-by-cell comparison is carried out, and the difference of the predictions is calculated for each cell (ij). Even this simple output makes it possible to specifically identify areas in the occupancy grid that were particularly poorly predicted. Finally, this cell-wise norm can be used to derive a statement of how good the prediction was.

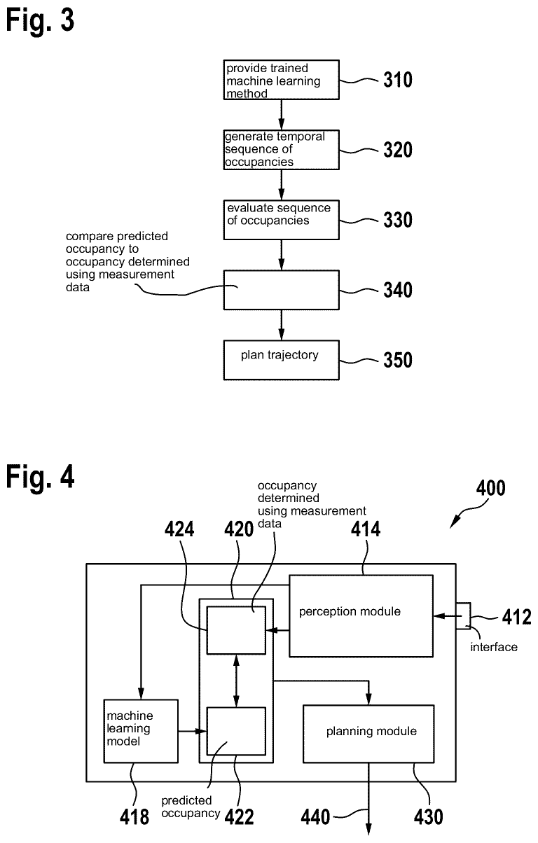

FIG. 3, by way of example, describes the sequence of a possible execution of a method according to the present invention for planning a trajectory for an at least partially automated vehicle.

In step 310, a machine learning model trained in advance is provided for determining the occupancy G(t0) of an occupancy grid. The machine learning model is trained to predict the occupancy G(t0) of the occupancy grid at a subsequent time t0 from a history G(t0-1), G(t0-2), . . . G(t0-H) of a specific length H of occupancies. A history may, for example, have a length of 3 to 5 seconds. At a conventional frame rate of 10 Hz, for example, this results in a history length of 30 to 50 images or occupancies of the occupancy grid G(t).

In step 320, a temporal sequence of occupancies B(t0-H), . . . B(t0-2), B(t0-1), B(t0) of the occupancy grid is generated by means of measurement data from the environment of the vehicle. Here, H also corresponds to the history length H. For example, the occupancies may be generated by means of lidar data of a lidar sensor of the vehicle, wherein a transformation of the occupancy data advantageously takes place on the basis of an ego movement of the vehicle.

In step 330, the sequence of occupancies (B(t0-H), . . . B(t0-2), B(t0-1) that has been determined in step 320 is evaluated by means of the machine learning model trained in advance, in order to predict a total occupancy G(t0) of the occupancy grid at a current time (t0).

In step 340, this predicted occupancy G(t0) of the occupancy grid at a current time (t0) is compared to the occupancy B(t0) determined by means of measurement data. Deviations between the measurement and the prediction are detected, and a location-dependent measure of a reliability of the occupancies (G(t0), B(t0)) or of the reliability of the known information is determined depending on the comparison. For example, in areas where the prediction differs significantly from the measurement, a low reliability of the occupancy information may be assumed. In particular, by determining a subjective logic opinion for each cell, values for a match, a deviation and an uncertainty can be determined for the comparison of measurement and prediction and a measure of the reliability can be derived therefrom.

In step 350, a trajectory for the at least partially automated vehicle will be planned on the basis of the reliability, in particular on the basis of detected deviations and/or a degree of uncertainty. Areas of the occupancy grid that have a high deviation and/or a high uncertainty may be avoided, for example.

FIG. 4 shows a system 400 for planning a trajectory for an at least partially automated vehicle. The system 400 comprises a machine learning module 418, a perception module 414, an interface 412 for receiving environmental sensor data, a comparison module 420, and a planning unit 430.

The machine learning module 418 is trained to predict the occupancy (G(t0)) of an occupancy grid at a subsequent time t0 from a history (G(t0-1), G(t0-2), . . . G(t0-H)) of a specific length H of occupancies. The perception module 414 is designed to determine occupancies (B(t)) of the occupancy grid by means of measurement data received or read from the interface 412 (cf. FIG. 1).

The comparison module 420 is configured to compare an occupancy 422 of the occupancy grid at a current time t0 that has been predicted by means of the machine learning module 418 to the occupancy 424 determined by means of measurement data, wherein deviations between the measurement and the prediction are in particular detected, and to determine, depending on the comparison, a location-dependent measure of a reliability of the occupancy information.

The planning module 430 is designed to plan a trajectory for the at least partially automated vehicle on the basis of the reliability, in particular on the basis of detected deviations and/or a degree of uncertainty, and to output 440 it to the vehicle.

What is claimed is:

1. A method for planning a trajectory for an at least partially automated vehicle, comprising the following steps:
a) providing a machine learning model, trained in advance, for determining occupancy of an occupancy grid, wherein the machine learning model is trained to predict the occupancy of the occupancy grid at a subsequent time from a history of a specific length of occupancies;
b) generating a temporal sequence of occupancies of the occupancy grid using measurement data from an environment of the vehicle;
c) evaluating, using the machine-learning model trained in advance, the sequence of occupancies that has been determined according to step b), to predict a total occupancy of the occupancy grid at a current time;
d) comparing the predicted occupancy of the occupancy grid at the current time to the occupancy determined using the measurement data, and detecting deviations between occupancy determined using the measurement data and the predicted occupancy, and determining a location-dependent measure of a reliability of occupancy information depending on the comparison;
e) planning a trajectory for the at least partially automated vehicle based on the reliability including based on the detected deviations and/or a degree of uncertainty.

2. The method according to claim 1, wherein a measure of the reliability is determined for a specific spatial area of a current occupancy depending on the deviation between the occupancy determined using the measurement data and the predicted occupancy, depending on the deviation and/or a measurement uncertainty, wherein the area includes at least one cell and/or multiple contiguous cells of the occupancy grid.

3. The method according to claim 1, wherein, in step d), a subjective logic opinion is determined for determining the reliability for each cell of the occupancy grid, wherein a tuple bᵢⱼ, dᵢⱼ, uᵢⱼ, aᵢⱼ is determined for each cell ij, wherein bᵢⱼ represents a match between the measurement and the prediction of the occupancy of the cell ij, dᵢⱼ represents a deviation between the measurement and the prediction of the occupancy of the cell ij, uᵢⱼ represents an uncertainty of the occupancy of the cell ij, and aᵢⱼ describes a basic probability of the occupancy of the cell ij.

4. The method according to claim 3, wherein, in step e), a trajectory planning for the vehicle takes place such that cells and/or areas of cells of the occupancy grid: (a) with a high deviation dᵢⱼ and/or a high uncertainty uᵢⱼ are avoided and/or (b) areas with a high match bᵢⱼ are preferred.

5. The method according to claim 1, wherein occupancy grids are transformed prior to processing by the machine learning model and/or prior to the comparison such that an ego movement of the vehicle is compensated.

6. The method according to claim 1, wherein input data for the machine learning model includes 3D tensors, wherein the 3D tensors each include occupancy grids of a specific environment at different times.

7. The method according to claim 6, wherein the machine learning model includes an encoder-decoder architecture, wherein output data for the machine learning model includes an occupancy grid of the same dimensions as the occupancy grids of the input data, but only for a specific time.

8. The method according to claim 1, wherein the machine learning model has an architecture in which spatial and temporal dimensions of input data are processed separately.

9. The method according to claim 1, wherein the machine learning model includes a recurrent network.

10. A non-transitory computer-readable medium on which is stored a computer program including commands for planning a trajectory for an at least partially automated vehicle, the commands, when executed by a processor, causing the processor to perform the following steps:
a) providing a machine learning model, trained in advance, for determining occupancy of an occupancy grid, wherein the machine learning model is trained to predict the occupancy of the occupancy grid at a subsequent time from a history of a specific length of occupancies;
b) generating a temporal sequence of occupancies of the occupancy grid using measurement data from an environment of the vehicle;
c) evaluating, using the machine-learning model trained in advance, the sequence of occupancies that has been determined according to step b), to predict a total occupancy of the occupancy grid at a current time;
d) comparing the predicted occupancy of the occupancy grid at the current time to the occupancy determined using the measurement data, and detecting deviations between occupancy determined using the measurement data and the predicted occupancy, and determining a location-dependent measure of a reliability of occupancy information depending on the comparison;
e) planning a trajectory for the at least partially automated vehicle based on the reliability including based on the detected deviations and/or a degree of uncertainty.

11. A system configured to plan a trajectory for an at least partially automated vehicle, the system comprising:
a machine learning module;
a perception module;
an interface configured to receive environmental sensor data;
a comparison module; and
a planning unit
wherein:
the machine learning module is trained to predict an occupancy of an occupancy grid at a subsequent time from a history of a specific length of occupancies,
the perception module is configured to determine occupancies of the occupancy grid using measurement data of an environment sensor system that have been received via the interface,
the comparison module is configured to compare an occupancy of the occupancy grid at a current time that has been predicted using the machine learning module to the occupancy determined using the measurement data, wherein deviations between the measurement and the prediction are detected, and to determine, depending on the comparison, a location-dependent measure of a reliability of occupancy information, and
the planning module is configured to plan a trajectory for the at least partially automated vehicle based on the reliability including based on the detected deviations and/or a degree of uncertainty.

12. A vehicle configured to drive in an at least partially automated manner, comprising:
a system configured to plan a trajectory for the at least partially automated vehicle, the system including:
a machine learning module;
a perception module;
an interface configured to receive environmental sensor data;
a comparison module; and
a planning unit;
wherein:
the machine learning module is trained to predict an occupancy of an occupancy grid at a subsequent time from a history of a specific length of occupancies,
the perception module is configured to determine occupancies of the occupancy grid using measurement data of an environment sensor system that have been received via the interface,
the comparison module is configured to compare an occupancy of the occupancy grid at a current time that has been predicted using the machine learning module to the occupancy determined using the measurement data, wherein deviations between the measurement and the prediction are detected, and to determine, depending on the comparison, a location-dependent measure of a reliability of occupancy information, and
the planning module is configured to plan a trajectory for the at least partially automated vehicle based on the reliability including based on the detected deviations and/or a degree of uncertainty.
